(19) United States
(12) Patent Application Publication
(10) Pub. No.: US 2018/0261898 A1
(43) Pub. Date: Sep. 13, 2018

(54) BATTERY MODULE FOR USE IN A HIGH-VOLTAGE ENERGY ACCUMULATOR

(71) Applicant: Dr. Ing. h.c. F. Porsche Aktiengesellschaft, Stuttgart (DE)

(72) Inventors: Philipp Kellner, Renningen (DE); Jens Bohlien, Stuttgart (DE)

(21) Appl. No.: 15/894,963

(22) Filed: Feb. 13, 2018

(30) Foreign Application Priority Data
Mar. 7, 2017 (DE) 10 2017 104 709.3

(51) Int. Cl. H01M 10/6556; H01M 2/10; H01M 10/613; H01M 10/625; H01M 10/647; H01M 10/6567; H01M 10/6569

(52) U.S. Cl. CPC H01M 10/6556; H01M 2/1077; H01M 10/613; H01M 2220/20; H01M 10/647; H01M 10/6567; H01M 10/6569; H01M 10/625

(57) ABSTRACT

A battery module includes a battery module housing and a plurality of battery cells accommodated by the battery module housing. The battery module housing includes an extruded profile and/or of a profile produced in a continuous manufacturing process and further includes media-conducting channels configured to control the temperature of the battery cells. A cross section of the profile surrounds the battery cells from four sides.

### CROSS REFERENCE TO RELATED APPLICATIONS

This application claims benefit to German Patent Application No. DE 10 2017 104 709.3, filed Mar. 7, 2017, which is hereby incorporated by reference herein.

### FIELD

The invention relates to a battery module for use in a high-voltage energy accumulator of an electrically drivable vehicle, wherein the battery module consists at least of a battery module housing and a plurality of battery cells accommodated by the battery module housing.

### BACKGROUND

High-voltage energy accumulators for electrically drivable vehicles require efficient cooling. It is known, for the cooling of large underfloor batteries, to use cooling channels in the form of thin-walled extruded profiles. These are complicated to produce and are expensive. Furthermore, they have to be pressed onto and/or adhesively bonded to a bulkhead plate or battery modules. This requires a non-optimal cooling effect since the cooling medium only reaches the bulkhead plate or the battery modules via the walls of the cooling channels and an adhesive film.

EP 2 017 919 A1 describes a battery pack in a housing provided with cooling channels. The housing has a housing upper part and a housing lower part which accommodate the battery pack between them and are mechanically connected to each other. The cooling medium flows in from the same side of the housing. On the remote side, the housing parts are connected to each other via deflected cooling channels, and therefore the cooling medium is deflected there. The production of such a housing or the production of the housing parts is highly complicated.

DE 10 2011 104 433 A1 discloses an energy accumulator module for a device for supplying voltage. Said energy accumulator module has a holding plate which has integrally formed fluid channels. The main body is connected in a heat-conducting manner by means of a heat-conducting adhesive bond to a cell module of the energy accumulator module for the exchange of thermal energy between the fluid and the cell module.

### SUMMARY

In an embodiment, the present invention provides a battery module comprising a battery module housing and a plurality of battery cells accommodated by the battery module housing. The battery module housing includes an extruded profile and/or a profile produced in a continuous manufacturing process and has media-conducting channels configured to control the temperature of the battery cells. A cross section of the profile surrounds the battery cells from four sides.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows, in an exploded illustration, a high-voltage energy accumulator with a battery box and various battery modules which are enclosed and accommodated by the latter;

FIG. 2 shows a first exemplary embodiment of a battery module with temperature control integrated on both sides, in a sectional illustration according to the line II-II in FIG. 3;

FIG. 3 shows this battery module in a sectional illustration according to the line in FIG. 2;

FIG. 4 shows a second exemplary embodiment of a battery module with temperature control integrated at the bottom, in a sectional illustration according to the line IV-IV in FIG. 5;

FIG. 5 shows this battery module in a sectional illustration according to the line V-V in FIG. 4;

FIG. 6 shows a third exemplary embodiment of a battery module with temperature control integrated at the bottom and top, in a sectional illustration according to the line VI-VI in FIG. 7; and

FIG. 7 shows this battery module in a sectional illustration according to the line VII-VII in FIG. 6.

### DETAILED DESCRIPTION

Embodiments of the present invention provide battery modules that, with a structurally particularly simple design and simple production of the battery module housing, enable efficient cooling of the battery cells accommodated by the battery module housing.

A battery module according to an embodiment of the invention includes a battery module housing and a plurality of battery cells accommodated by the battery module housing. The battery module housing includes an extruded profile and/or of a profile produced in a continuous manufacturing process. Said profile has media-conducting channels for controlling the temperature of the battery cells. The profile cross section surrounds the battery cells from four sides.

Accordingly, the battery module is distinguished in that the cooling medium is directly integrated in the battery module housing. Particularly good cooling efficiency can thereby be achieved. Since the battery module housing includes the profile produced in an extruded and/or in a continuous manufacturing process, the battery module housing can be produced simply and cost-effectively. During the production of the profile, and therefore of the battery module housing, the media-conducting channels which serve for controlling the temperature of the battery cells are directly produced. Since the profile cross section surrounds the battery cells from four sides, optimum cooling is ensured.

It is thus considered to be particularly advantageous if the profile cross section constitutes two lateral boundaries and an upper and a lower boundary of the battery module. It is additionally provided in this connection that the battery module housing is closed by separate end plates to form a cuboidal structure.

The profile is composed in particular of a light metal. It is considered to be particularly advantageous if the light metal is aluminum, an aluminum alloy, magnesium or a magnesium alloy.

It is provided, for example, that the profile is produced by means of extrusion. Alternatively, it can be a profile composed of a fiber/plastic composite. This profile is produced in particular by means of braiding and/or pultrusion. In a further alternative, it is provided that the profile is produced from plastic or fiber-reinforced plastic. In this case, it is considered to be preferred if the profile is produced by means of extrusion.

It is considered to be particularly advantageous if the wall portions of the battery module housing are designed as load paths. The load paths are preferably integrated in the two lateral or the upper and lower wall portions of the battery module housing. It is considered to be particularly advantageous here if the wall portions forming load paths have greater wall thicknesses than the wall portions of the profile cross section that do not form load paths.

The battery module housing preferably has, in a wall portion of the battery module housing or in two lateral wall portions of the battery module housing, media-conducting channels which are integrated in said wall portion or portions, for controlling the temperature. This arrangement of the media-conducting channels is sufficient in order to ensure efficient cooling of the battery cells. In particular, it is provided that the battery module housing has, in a lower wall portion of the battery module housing, media-conducting channels which are integrated into said wall portion, for controlling the temperature.

According to a preferred development, it is provided that the integrated media-conducting channels are integrated into the extrusion profile forming the module housing or the extrusion profiles forming the module housing.

A battery module, in particular such a battery module which is described in conjunction with the previously described developments, is used in particular in the case of a high-voltage energy accumulator. Said high-voltage energy accumulator of an electrically drivable vehicle consists in particular of a battery box and a plurality of battery modules which are accommodated by the battery box.

The particular advantage of the design of the battery module or of the high-voltage energy accumulator can be seen in the improvement of the cooling efficiency, the integration of functions, the reduction in weight and costs and the low amount of construction space required.

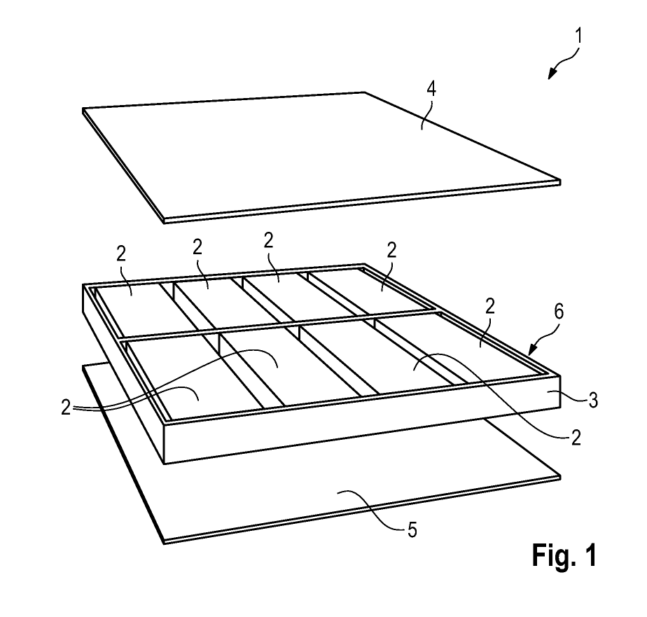

FIG. 1 shows a high-voltage energy accumulator 1 for use in an electrically drivable vehicle. The high-voltage energy accumulator 1 has a battery box and a plurality of battery modules 2 accommodated by the latter. The battery box has a central battery frame structure 3 and also a battery housing cover 4 and a battery housing base 5. In the case of the battery housing base 5 which is connected to the battery frame structure 3, this arrangement completely accommodates the battery modules 2. The arrangement is then closed by means of the battery housing cover 4. Eight battery modules 2 which are accommodated by the battery box are shown. Said battery modules 2 are of identical design. Each battery module 2 consists at least of a battery module housing 6 and a plurality of battery cells 14 which are enclosed/accommodated by the battery module housing 6 and are not illustrated in said FIG. 1.

The battery module housing 6 consists at least partially of an extruded profile and/or of a profile produced in a continuous manufacturing process. Said profile has media-conducting channels for controlling the temperature of the battery cells. The profile cross section surrounds the battery cell from four sides here. Owing to this design of the battery module housing 6, only a rectilinear channel geometry is possible in the profile. Consequently, no deflection or no deflections is or are possible in the profile.

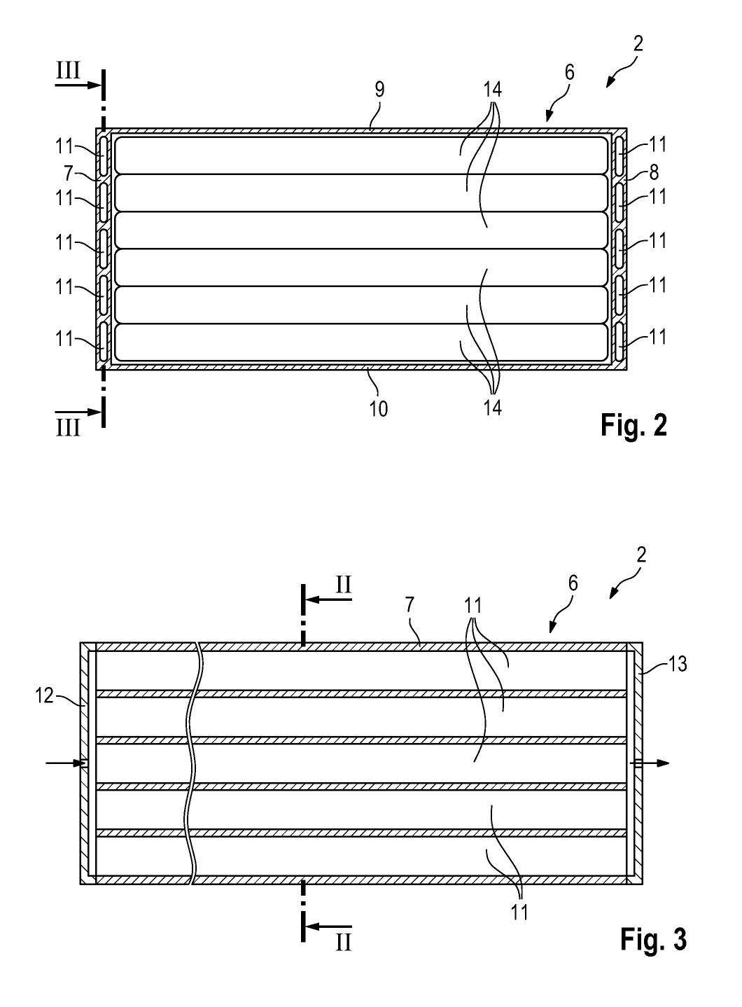

Battery modules 2 with three different preferred exemplary embodiments of battery module housings 6 are explained in FIGS. 2 to 7:

In the case of the first exemplary embodiment according to FIGS. 2 and 3, a battery module housing 6 with laterally integrated temperature control is illustrated. A rectangular profile cross section with two lateral wall portions 7, 8, an upper wall portion 9 and a lower wall portion 10 is shown. The wall portions 9 and 10 are of thin-walled design relative to the wall portions 7 and 8. Five channels 11 are in each case integrated in the lateral wall portions 7, 8. Since said channels 11 are provided in the region of the lateral wall portions 7, 8, they each have an extent in the vertical direction that is significantly greater than in the width direction of the particular wall portion 7 or 8. The extent of the wall portions 7 and 8 in the vertical direction is smaller than that of the wall portions 10, 11 in the width direction. The extent is approximately half.

In the region of the remote end sides, the battery module housing 6 is closed by separate end plates 12, 13. These parts therefore form a cuboidal arrangement.

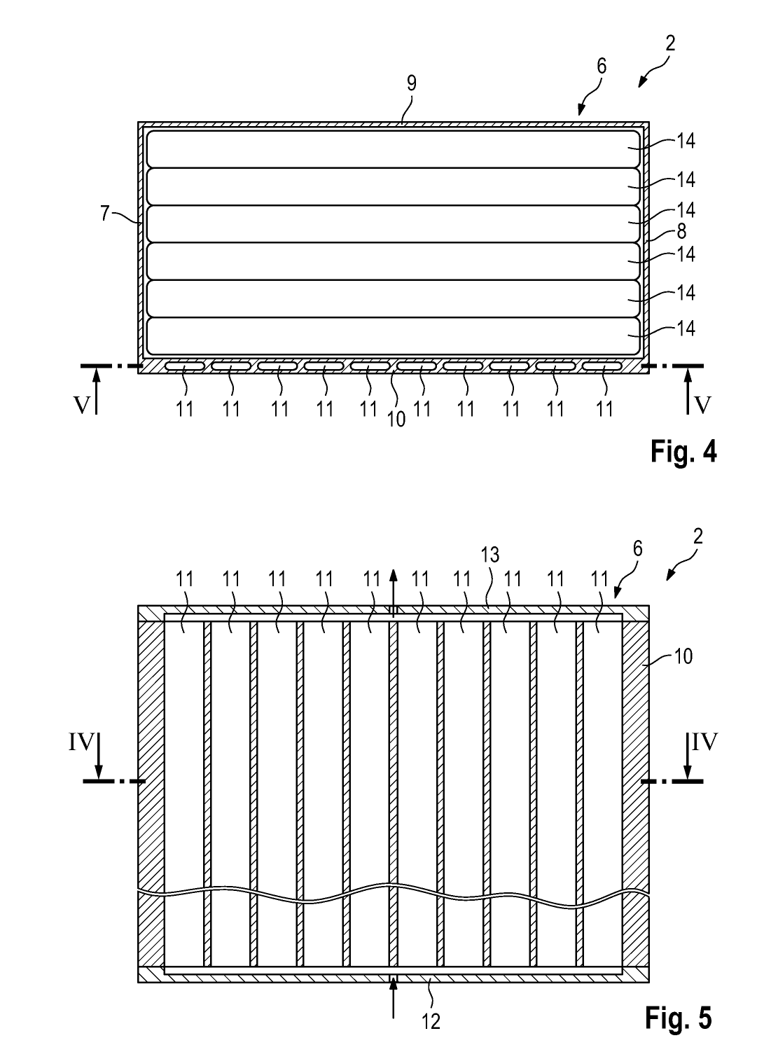

In the case of the second exemplary embodiment according to FIGS. 4 and 5, the wall portions 7, 8 and 9 are of relatively thin-walled design, and the lower wall portion 10 is of relatively thick-walled design. Channels 11, specifically ten channels 11, are provided exclusively in the region of the lower wall portion 10. Said channels extend with a greater length in the width direction of the battery module housing 6 than in the vertical direction of the battery module housing 6. Furthermore, reference is made with respect to this exemplary embodiment to the explanations regarding the first exemplary embodiment.

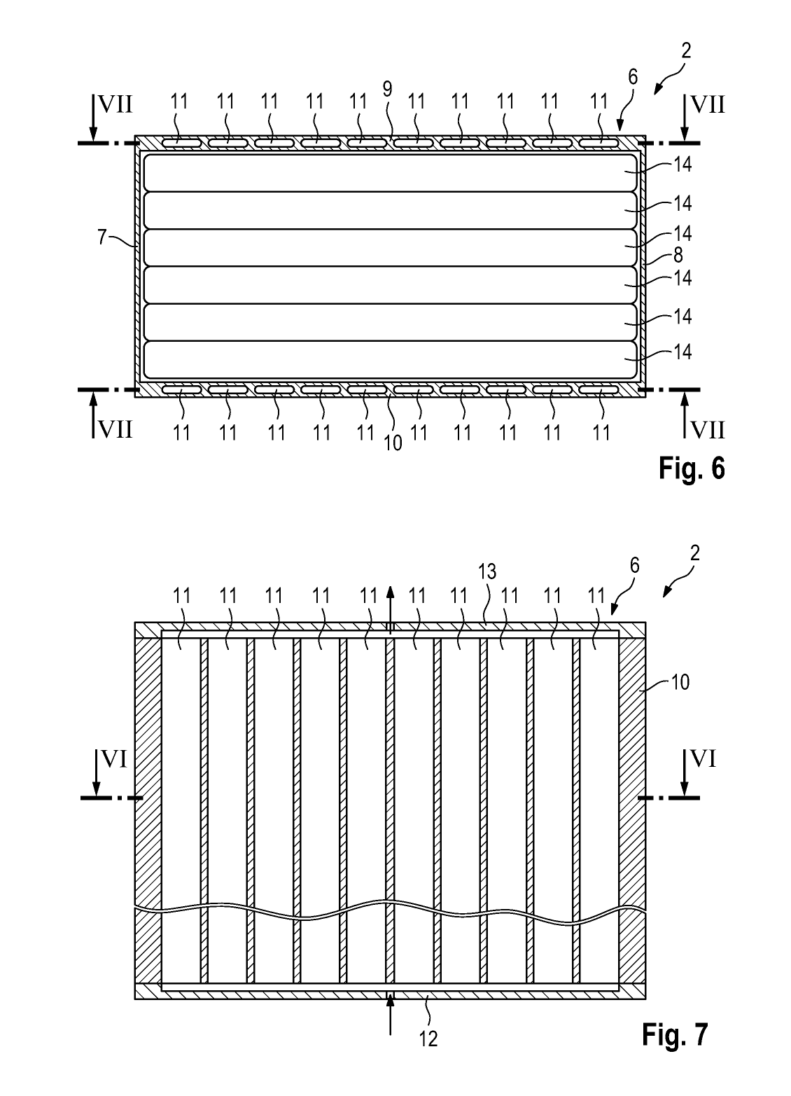

In the case of the third exemplary embodiment according to FIGS. 6 and 7, the wall portions 7 and 8 are of relatively thin-walled design and the wall portions 9 and 10 are of relatively thick-walled design. The wall portions 9 and 10 are provided with the channels 11. Specifically, each wall portion 9 or 10 has ten channels 11. The wall portions 9, 10 are designed in a manner corresponding to the wall portion 10 according to the second exemplary embodiment. With regard to the further details, reference is made with respect to this third exemplary embodiment to the explanations regarding the first exemplary embodiment.

The profile having the rectilinear channel geometry is composed, for example, of light metal, in particular of aluminum, an aluminum alloy, of magnesium or a magnesium alloy.

In particular, the profile is produced by means of extrusion. Alternatively, the profile can consist of a fiber/plastic composite. In this case, the profile is produced in particular by means of braiding and/or pultrusion. Finally, the profile can be produced from a plastic or fiber-reinforced plastic. The profile is produced here in particular by means of extrusion.

The high-voltage energy accumulator 1 has, for example, water, a water/glycol mixture, an evaporating refrigerant, oil or another liquid as the medium.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 High-voltage energy accumulator

2 Battery module

3 Battery frame structure

4 Battery housing cover

5 Battery housing base

6 Battery module housing

7 Lateral wall portion

8 Lateral wall portion

9 Upper wall portion

10 Lower wall portion

11 Channel

12 End plate

13 End plate

14 Battery cell

What is claimed is:

1. A battery module comprising:
a battery module housing; and
a plurality of battery cells accommodated by the battery module housing,
wherein the battery module housing includes an extruded profile and/or a profile produced in a continuous manufacturing process and has media-conducting channels configured to control the temperature of the battery cells,
wherein a cross section of the profile surrounds the battery cells from four sides.

2. The battery module as claimed in claim 1, wherein the cross section of the profile constitutes two lateral boundaries and an upper and a lower boundary of the battery module, wherein the battery module housing is closed by separate end plates to form a cuboidal structure.

3. The battery module as claimed in claim 1, wherein the battery module housing has load paths.

4. The battery module as claimed in claim 3, wherein the two lateral boundaries and/or the upper and lower boundary of the battery module housing constitute the load paths.

5. The battery module as claimed in claim 3, wherein boundaries forming load paths have greater thicknesses than boundaries not forming load paths.

6. The battery module as claimed in claim 1, wherein the profile includes one or more of aluminum, magnesium, or an alloy of aluminum or magnesium.

7. The battery module as claimed in claim 1, wherein the profile is produced by extrusion.

8. The battery module as claimed in claim 1, wherein the profile includes a fiber/plastic composite.

9. The battery module as claimed in claim 8, wherein the profile is produced by braiding and/or pultrusion.

10. The battery module as claimed in claim 1, wherein the profile is produced from plastic or fiber-reinforced plastic.

11. The battery module as claimed in claim 10, wherein the profile is produced by extrusion.

12. The battery module as claimed in claim 1, wherein the battery module housing includes, in a wall portion of the battery module housing or in two lateral wall portions of the battery module housing, media-conducting channels which are integrated in the wall portions, for controlling the temperature of the battery cells.

13. The battery module as claimed in claim 1, wherein the battery module housing includes, in a lower wall portion of the battery module housing and/or in an upper wall portion of the battery module housing, media-conducting channels which are integrated in the wall portions, for controlling the temperature of the battery cells.

14. The battery module as claimed in claim 1, wherein the integrated media-conducting channels are integrated into the profile forming the module housing.

15. The battery module as claimed in claim 1, wherein the battery module housing includes water, a water/glycol mixture, evaporating refrigerant, or oil as a medium for controlling the temperature of the battery cells.

16. A high-voltage energy accumulator of an electrically drivable vehicle, comprising:
a battery box configured to accommodate a plurality of battery modules, wherein the battery modules are configured as claimed in claim 1.
